(19) United States
(12) Patent Application Publication
(10) Pub. No.: US 2025/0058664 A1
(43) Pub. Date: Feb. 20, 2025

(54) Device and method for controlling the charging power while charging a device to be charged using a smart charging cable

(71) Applicant: eClever technology GmbH, Dresden (DE)

(72) Inventor: Oliver Raguse, Bannewitz (DE)

(21) Appl. No.: 18/718,833

(22) PCT Filed: Dec. 12, 2022
(86) PCT No.: PCT/EP2022/085473

§ 371 Date: Jun. 12, 2024

(30) Foreign Application Priority Data
Dec. 12, 2021 (LU) LU500995

(51) Int. Cl. B60L 53/30; B60L 53/16; B60L 53/18; B60L 53/62; B60L 53/68; H02J 7/00

(52) U.S. Cl. CPC B60L 53/305; B60L 53/16; B60L 53/18; B60L 53/62; B60L 53/68; H02J 7/0042

(57) ABSTRACT

The present invention relates to the field of charging power control during charging of a device to be charged, in particular an electric vehicle, in particular the charging power control by a smart charging cable and a method for controlling and/or terminating the charging process of a device to be charged by a smart charging cable. The charging cable according to the invention is characterized by an electronics, comprising a communication interface, which is designed in such a way that it enables coupling with at least one computing unit and thus makes the charging process controllable and/or terminable by a user and/or a computer program product.

### TECHNICAL FIELD

The present invention relates to the field of charging and controlling and/or terminating a charging process of a device to be charged, in particular an electric vehicle, in particular the charging of an electric vehicle at a charging station with a three-phase, alternating current or direct current connection. In addition, the invention relates to a suitable single-phase or multi-phase device, preferably a charging cable, which comprises integrated electronics with at least one communication interface for coupling the charging cable with at least one computing unit, set up to make the charging process of the device to be charged, in particular of the electric vehicle, controllable and/or terminable by the computing unit.

### STATE OF THE ART

Charging cables for charging the batteries of devices, in particular electric vehicles, are well known from the state of the art. Conventional charging cables are preferably single-phase or multi-phase and are designed so that they are mechanically and electrically coupled to a charging station via a plug connector to enable charging with alternating, direct or three-phase current. Charging cables with an integrated function for monitoring the charging process are also already known. For example, charging cables (e.g. from the company Bosch) are available that include an “in-cable control box” or electronics integrated in the connector.

DE 20 2021 104 997 U1 discloses a mobile charging cable for controlling the charging of accumulators which is characterized by the fact that the charging cable has a communication interface which is set up in such a way that it serves to identify a grid connection device, in particular to distinguish a grid connection cable (also: charging cable) and a grid connection station (also: charging station, charging column, charging device), and to identify the charging cable to the grid connection device. Herein, a charging control unit is mechanically and electrically coupled to a grid connection station via a plug connector, whereby the grid connection station is set up in such a way that it can be connected to the electrical power supply grid.

Such a device is used to electrically couple a device comprising an accumulator, in particular an electric vehicle, to the power grid via a charging cable and grid connection station, whereby the charging cable and the grid connection station are mutually identifiable by the communication interface comprised by the charging cable. For example, charging at a grid connection device can be prohibited if it is not compatible with the mobile charging cable used, or charging of the electric vehicle at this grid connection device is not permitted for other reasons (e.g. lack of authorization). The earthing of the electric vehicle via the grid connection cable and the grid connection station is also controlled by the battery management system (BMS) installed in the device to be charged.

Furthermore, DE 20 2021 104 997 U1 discloses the use of a charging control unit comprising a housing, a grid-side connector and a consumer-side connector, whereby this is designed in such a way that it contains the electronic components required for charging a battery, in particular an electric vehicle. Preferably, the charging control unit performs the necessary control and protection functions, such as limiting the charging current, checking the polarity of the connectors and ensuring the continuity of the protective earthing up to the device to be charged.

However, the state of the art does not disclose any way of regulating the charging current when charging an electric vehicle with direct current at so-called fast charging stations. There is also no known way of limiting the charging process when charging with direct current. The charging control unit disclosed in DE 20 2021 104 997 U1 has the function of providing an alternating current for charging on the device side. The conversion of the alternating current is carried out only on the side of the device to be charged, preferably the electric vehicle.

Furthermore, the state of the art does not disclose any possibility of controlling and/or terminating the charging process remotely. It is not possible for a user to check the charging process from a spatial distance and adapt it to the current grid load, for example, or to release the charging station to which his device to be charged, in particular his electric vehicle, is connected for other users after the charging process has ended.

US 2020/0180460 A1 relates to a smart charging cable that enables dynamic and remote charging of a battery as may occur in an electric vehicle (“EV”). The EV charging cable is not specific to a particular manufacturer or brand of electric vehicle, allowing for unrestricted application and access to vehicle charging. The EV charging cable contains a processor to execute instructions stored in a memory and a communication module for wireless communication between the cable and a remote source. An auto-emulator can be used to simulate the presence of a vehicle to enable switched high power sources such as standard installed EF chargers, as well as a power meter to measure the current flowing through the cable. The aforementioned components can be housed in a switch box located between two parts of the cable to receive power from a source and deliver it to a battery. The charging cable has a plurality of electronic switches and a safety module, wherein the switches are arranged to selectively and safely control the transfer of power through the EV charging cable. A charging schedule can be obtained from a cloud, for example, and match the desired charging requirements and/or criteria of the vehicle.

US 2016/0121743 A1 discloses a system for charging an electric vehicle, wherein the system uses an in-cable control box (ICCB) and comprises an electrical connection device for slow charging that supplies electricity to a vehicle. The electricity is supplied via an RFID socket when the electrical connection device is coupled to the RFID socket to charge the vehicle, wherein the electrical connection device collects information on the electrical energy used to charge the vehicle and information on a position at which the vehicle is charged to charge electricity according to an electricity rate applicable to the vehicle. By means of a server of a charging service provider, the electric connection device can transmit the information on the position where the vehicle is charged and the information on the electric energy to the electric utility company that charges for the electricity used to charge the vehicle. The vehicle information (vehicle condition, battery status, etc.) collected by a data communication unit can be used by the charging service provider for the setup of a future business model.

CN 111883975 A discloses a plug holder which has a holder, a socket and a locking mechanism, wherein the socket has an opening which is designed for inserting and removing a charging plug of an electric vehicle, wherein the socket is coupled to the holder so as to be movable such that the socket can be tilted about a transverse axis from a plug-in position downwards into a rest position and vice versa. The locking mechanism is designed in such a way that the socket is locked when tilted into the rest position so that the charging plug is held in the socket to prevent the charging plug from falling out. The socket is unlocked when tilted into the plug-in position so that the charging plug can be removed from the socket.

DE 10 2013 224 735 A1 discloses a charging cable device with which different vehicles can be charged at different positions of the charging input, wherein the charging cable device is long enough to reach the parked vehicle at different parking positions in relation to the power supply station (i.e. a charging station). The charging cable device has a connector into which another charging cable device can be plugged.

WO 2019/007466 A1 discloses a charging arrangement for an electric vehicle with a traction battery and comprises a power supply station connected to a power grid and a power supply cable with a charging plug, wherein the charging plug is coupled to the electric vehicle to carry out a charging process, wherein a voltage converter is arranged in the charging plug to convert the supply voltage provided by the power supply station into a charging voltage that is lower than the supply voltage. The voltage converter makes it possible to reduce the wire cross-sections of the electrical wires within the power supply cable. A wireless communication module can be arranged in or on the charging plug itself or between the charging plug and the power supply station. Bluetooth or WLAN, for example, can be used as the wireless communication standard. A mobile network standard, such as GSM, can also be used as a wireless communication standard so that corresponding data can be transmitted. For example, information about the charging process, the price of the charging process or the charge status of the traction battery can be passed on. This information can then be displayed on a corresponding software application (app) on a mobile device, such as a smartphone. It is also disclosed that charging management can be provided at a charging point for several electric vehicles. For example, two or more charging plugs can each be connected to the voltage supply station via a voltage supply cable. The individual charging plugs can preferably communicate with each other and regulate an optimum/required charging power for each electric vehicle. Furthermore, the communication module can communicate with the power supply station or with a server, for example.

DE 10 2021 203 362 A1 discloses a charging cable for electrically charging an energy storage device of a hybrid or electric vehicle, comprising a charging line, wherein the charging line comprises a first connection device, wherein the first connection device can be detachably electrically connected to the energy storage device of the hybrid or electric vehicle. The charging cable also comprises a second connection device, wherein the second connection device can be directly or indirectly detachably electrically connected to an energy supply device, wherein the charging cable comprises at least one control unit and/or at least one switching unit and/or at least one communication unit. The charging process is advantageously started without having to initiate prior identification and authorization of the person requesting the charging current via an RFID card, a connection to the cell phone or a credit card. This means that no additional action not directly related to the charging process is necessary for the person requesting the charging current. It is sufficient to simply plug in the cable, as the system authorizes itself automatically. For this purpose, at least one control unit and/or the at least one switching unit and/or the at least one communication unit is accommodated along the charging line. The communication unit can advantageously communicate by cable with the vehicle or with a switchable socket, for example by performing an identification and authorizing the switchable socket for use after a check. By means of wireless communication communication is preferably carried out with a charging controller or user interface or energy meter. The switchable socket, which is, for example, stationary or permanently installed, cannot be used arbitrarily by unauthorized charging cables to charge an energy storage device, but can only be enabled with the disclosed charging cable.

DE 10 2015 208 786 A1 discloses a communication module for an electric charging process of a vehicle at a charging station via a charging cable, whereby the user of a vehicle, which uses a communication protocol with a limited range of functions for a charging process, is enabled to use the functions provided by a charging station in an efficient and convenient manner. For this purpose, the vehicle is set up to communicate via the charging cable in accordance with a first communication protocol. The charging station is set up to communicate via the charging cable in accordance with a second communication protocol. The second communication protocol enables the transmission of data that cannot be transmitted using the first communication protocol. The communication module is set up to receive charging station data from the charging station in accordance with the second communication protocol. The communication module is further set up to send data corresponding to the charging station data to the vehicle in accordance with the first communication protocol if the first communication protocol enables the transmission of the charging station data. Furthermore, the communication module is set up to send data corresponding to the charging station data to a user unit via a transmission medium separate from the charging cable if the first communication protocol does not enable the transmission of the charging station data.

DE 10 2017 222 968 A1 discloses a charging cable for charging an electrical energy storage device of a vehicle. The charging cable comprises a vehicle-side plug with a plug-in element that is designed to be plugged into a complementary plug-in element of the vehicle. The vehicle-side plug comprises a housing in the form of a handle, which encloses a control unit that is set up to communicate with a charging control unit of the vehicle in order to control a charging process of the vehicle's electrical energy storage system. In addition, the charging cable comprises a supply-side plug adapted to be coupled to an electrical power supply and a cable extending between the supply-side plug and the vehicle-side plug adapted to transmit electrical energy for the charging process from the supply-side plug to the vehicle-side plug. The vehicle-side plug can comprise a communication module that is set up to communicate with an external unit via a wireless communication link, wherein the external unit can comprise an electronic device of the user (e.g. a smartphone) and/or a control unit of the vehicle. In particular, the communication module can communicate with a server that can be accessed by the electronic device (e.g. via an app). Communication between the vehicle-side plug and the electronic device can thus be carried out indirectly via a server. The control unit can be set up to receive control data via the communication module to control the charging process. In particular, the electronic device can be enabled (e.g. via an app) to allow a user to intervene in a charging process, e.g. to change the charging power.

### Objective

The objective of the present invention is therefore to provide a device that enables the charging process of a device to be charged to be controlled and/or terminated by a user from a spatial distance. The device has the task of monitoring the charging power transmitted by the charging station, setting the charging power according to the user's wishes and/or taking into account the current grid load and releasing the charging station in a manner recognizable to other users after the charging process has ended.

Furthermore, the present invention has the objective of providing a device that is functional regardless of the type of charging in question, i.e. regardless of whether direct current, alternating current or three-phase current is used for charging.

### Solution

The technical objective is solved by providing a smart charging cable (1) which makes it possible to monitor and control the charging of a device to be charged (4), in particular an electric vehicle, wherein the charging cable has control and protection functions. These comprise a charging current limitation, a control of the polarity of the connectors and ensuring the continuity of the protective earthing up to the device to be charged (4), wherein the charging cable (1) according to the invention is suitable for controlling the charging process by at least one data communication interface via a spatially remote, in particular mobile, computing unit (2) via a computer program product, preferably an application (also: app).

According to the invention, this task is solved by a smart charging cable (1) according to claim 1, which is set up to monitor and control the charging of a device to be charged (4), wherein the charging cable comprises at least one communication interface which is set up in such a way that it enables communication with a computing unit (2) by means of which the charging power can be monitored and adjusted.

Further advantageous embodiments can be found in the sub-claims, the description and the embodiments.

### General Advantages

Advantageously, the device according to the invention enables the user of the device to be charged (4) to adapt and control the charging process of his device, even if he is spatially remote from the device to be charged. Thus, the charging process can be adapted with regard to the grid load, the status of the accumulator of the device to be charged (4) and external environmental conditions (e.g. temperature). For example, if the grid load is high at a given time, the charging process can be interrupted by the user and continued at a later time. It is also advantageous to be able to adapt the charging process to the current supply situation. The electricity price varies throughout the day due to fluctuating grid feed-ins from renewable energies depending on the time of day and weather conditions. The device (1) according to the invention enables the user to adapt the charging process so that he can charge at a favorable rate.

The smart charging cable (1) makes it possible to control and adapt the charging processes of several devices (4) (41) to be charged, which are coupled to one or more charging stations (3) via one or more charging cables according to the invention. If, for example, one device to be charged (4) is to complete the charging process earlier than another, the charging process can be adjusted accordingly by means of the device according to the invention. Further advantages can be found in the description and the embodiment examples.

### DETAILED DESCRIPTION OF THE INVENTION

The device according to the invention is essentially a smart charging cable (1) for controlling the charging power of devices (4) to be charged, preferably electric vehicles, in particular a smart charging cable for charging electric vehicles (also: electric vehicle charging cable). The device comprises a single-phase or multi-phase, grid-side charging cable connector (10) for mechanically and electrically coupling the charging cable according to the invention to a charging station (also: charging column, charging device, grid connection station). The grid-side charging cable connector (10) is set up in such a way that it has signal contacts and contacts for transmitting energy. The signal contacts include a proximity pilot contact (also: or plug-present contact) (PP), herein referred to as charging cable detection contact (102), which can detect the presence of a charging station plug/connector, and a control pilot contact (CP), herein referred to as control/data line (101), which is used to exchange control signals between the device to be charged (4) and the charging station (3). The contacts for energy transmission are preferably set up in such a way that they comprise outer phases, further referred to as phases, as well as a neutral line (107) and a protective earth (105). The protective earth (105) is preferably set up in such a way that it ensures earthing and personal protection. The neutral line (107) is preferably set up in such a way that it ensures the equalization of phase shifts of the currents in the phases. In a preferred embodiment, the grid-side charging cable connector (10) is a plug that conforms to the EN 62196 type 2 standard, but an embodiment with a plug that conforms to the SAE J 1772 type 1 standard is also possible. Such a setup advantageously enables charging of the device to be charged (4) via up to three phases (103) (104) (106), whereby a shorter charging time can be achieved with the use of the additional phases. In addition, earthing of the device to be charged (4) is ensured during the entire charging process via the protective earth (105).

For the purposes of the invention, an electric vehicle is a mobile means of traffic and/or transportation (e.g. automobiles, motorcycles, watercraft, aircraft) which is designed to be at least partly or completely driven by an electric motor. Preferably, these are means of traffic and/or transportation for movement on roads or on land, but may also include vehicles on water and/or in the air. A characteristic feature of an electric vehicle is that it has an electric motor which is powered by energy from an accumulator.

The task is solved in particular by a smart charging cable for controlling the charging power of accumulators of devices to be charged, in particular electric vehicles, which is preferably designed as a smart electric vehicle charging cable and which comprises the following: an at least single-phase, grid-side charging cable connector, wherein this is set up as a coupling element of the charging cable and a charging station, an at least single-phase, vehicle-side charging cable connector, wherein this is set up as a coupling element of the charging cable and a device to be charged, a housing which comprises electronics by means of which a charging power can be set, wherein the electronics are set up for monitoring and/or setting the charging current on at least one phase, and/or the electronics comprise a communication interface which is set up in such a way that it comprises at least one signal transmission means by which a transmission of a data signal or a data sequence can be transmitted to at least one computing unit (2), and the communication interface is designed in such a way that it enables data communication with the computing unit (2), wherein the charging power can be monitored and adjusted by the data communication with the computing unit.

Preferably, the housing also has at least one measuring device which is set up to measure an electrical current and/or an electrical power. This makes it possible to check whether the activation is being carried out correctly and the measured values can be used advantageously for billing.

A further aspect of the invention relates to a smart charging cable for controlling the charging power of accumulators of devices to be charged, in particular electric vehicles. The smart charging cable comprises an at least single-phase, grid-side charging cable connector, which is set up as a coupling element of the charging cable and a charging station. In addition, the smart charging cable comprises an at least single-phase, vehicle-side charging cable connector, which is set up as a coupling element for the charging cable and a device to be charged. Furthermore, the smart charging cable comprises a housing with electronics that are set up to adjust the charging power. The electronics are set up for monitoring and/or adjusting the charging current on at least one phase, wherein the electronics comprise a communication interface which is set up in such a way that it comprises at least one signal transmission means which is set up for transmitting a data signal or a data sequence to at least one computing unit, wherein the communication interface is designed in such a way that it enables data communication with the computing unit (2), wherein the computing unit is set up to monitor and/or adjust the charging power. Preferably, the charging cable comprises a mechanism which is set up to eject the grid-side and/or vehicle-side connector, wherein the ejection can be controlled from a computing unit which is spatially remote from the charging cable.

According to one embodiment, a user can operate the eject mechanism via an application (also: app) on a mobile device (e.g. tablet, smartphone). The advantage of this is that the user can initiate the ejection himself if desired.

In the following, the device to be charged (4) is referred to as an electric vehicle. However, it is also possible to use the method disclosed herein for another device comprising a rechargeable battery. Such a device can be, for example, a laptop, a tablet or a smartphone. The following designation of the device to be charged (4) as an electric vehicle is not to be understood restrictively.

For the purposes of the invention, charging station (3) is to be understood as a device that provides electrical energy for charging an electric vehicle (4). Such a device can be, for example, an alternating current, direct current or three-phase current charging station. In particular, it can be designed as a charging station, wallbox or generally as a socket.

Furthermore, the smart charging cable (1) according to the invention comprises a single-phase or multi-phase charging cable connector (11) on the device side (referred to herein as the vehicle-side charging cable connector or vehicle connection) for coupling the smart charging cable to a device to be charged (4), in particular an electric vehicle. The vehicle-side charging cable connector (11) is preferably designed in such a way that it is similar in setup to the grid-side charging cable connector (10). This has the advantage that no conversion between different connection principles using electronics and no adapter is necessary.

For the purposes of the invention, a “smart charging cable” refers to a charging cable comprising functions that enable the charging process of an electric vehicle (4) to be controlled and/or terminated by a user via at least one computing unit (2). For this purpose, the charging cable (1) according to the invention also comprises a housing (12) which is designed in such a way that it comprises electronics. The electronics are preferably set up in such a way that they enable monitoring and/or adjustment of the charging power of the electric vehicle (4) by monitoring and/or adjusting the charging current on at least one phase. The monitoring and/or adjustment of the charging power is preferably carried out by connecting a shunt (also: shunt resistor). The skilled person understands a shunt to be a resistor which, in this case, is connected in parallel with the phase to be monitored in order to prevent a current flow from the charging station (3) to the electric vehicle or to the accumulator of the device to be charged. The shunt is preferably designed in such a way that it can be controlled electronically and/or electromechanically by the electronics installed in the housing (12). This means that the charging power can be controlled during the charging process by the smart charging cable (1) by preventing or enabling the flow of current via the individual phases to the electric vehicle (4) by switching a shunt on or off. In one embodiment, the housing (12) comprising the electronics is designed in such a way that it is arranged downstream of the vehicle-side charging cable connector (11) and/or a grid-side charging cable connector (10) of the charging cable (1) according to the invention. Preferably, the housing (12) is integrated into a plug head of the charging cable (1) according to the invention. Advantageously, a space-saving setup can thus be realized, whereby an in-cable control box can be dispensed with. In a further embodiment, the housing (12) comprising the electronics is designed as an in-cable control box. This embodiment advantageously ensures that the electronics enclosed by the housing (12) are easily accessible, replaceable and maintainable. Such an embodiment is easy to retrofit if further functions are desired by the user.

Furthermore, an embodiment is possible in which the housing (12) is integrated into a wiring system. By a wiring system (also switch cabinet), the skilled person means a system consisting of wiring, which is used for the electrical connection of individual electrically functional components, and a framework system, in particular a rail system, e.g. a system comprising top-hat rails, comb profiles and/or brackets. Preferably, the wiring system, which comprises the housing (12), is integrated in the charging station (3). This means that the charging process can be controlled and/or terminated directly via the charging station (3).

The charging cable (1) according to the invention also comprises at least one communication interface integrated into the housing (12). The communication interface is preferably designed such that it comprises at least one signal transmission means for enabling data transmission via, for example, Bluetooth and/or WLAN and/or mobile communications, e.g. LTE, and/or LoRaWAN, which is set up to transmit a data signal or a data sequence to at least one computing unit (2), preferably to a spatially remote, external computing unit, i.e. not assigned to the electric vehicle (4). The communication interface herein is set up in such a way that it enables communication with the computing unit (2), so that the charging power can be advantageously monitored and/or adjusted via the electronics integrated in the housing (12).

In accordance with one embodiment, the housing comprising the charging cable provides at least one charging cable connector for at least one further charging cable. This advantageously enables charging cables of the same design according to the invention to be plugged into one another in order to produce a charging cable extended by the charging cables plugged into one another.

According to one embodiment, the housing comprised by the charging cable is set up in such a way that it can be coupled by a user to a charging unit and at least one other housing, so that at least one charging option for a device to be charged is provided on each coupled housing.

For the purposes of the invention, the term computing unit refers to a computing system comprising a processor unit, a communication interface for transmitting and receiving data and a computer-readable storage medium, wherein the storage medium contains a computer program product, also a software product, which contains instructions for controlling and/or terminating the charging process by a charging cable (1) according to the invention. Such a computing unit is, for example, an external, mobile computing unit, such as a smartphone or a tablet, or also a stationary computing unit, such as a PC, or a distributed computing unit, in particular a cloud. However, computing units integrated in the electric vehicle (4), i.e. internal computing units, such as those included in the BMS, are also conceivable.

Preferably, the charging cable (1) according to the invention enables coupling with at least one spatially remote computing unit (2) via the included communication interface, whereby the distance can range from a few meters, for example to the smartphone of a user standing next to the electric vehicle (4), to any number of kilometers, for example to a cloud server in a company headquarters. It is therefore possible for the user to control and/or terminate the charging process of the electric vehicle via the computing unit (2), in particular from a distance, but also from close proximity to the electric vehicle and the charging station.

In a particularly preferred embodiment, the housing (12) is designed as an in-cable control box, wherein the housing comprises a plurality of connectors. The connectors are set up in such a way that they enable the housing (12) to be connected to a charging unit, in particular a wallbox, by a user using a cable intended for this purpose. The connection is carried out according to a plug-in principle, whereby the connectors of the cable are designed analogously to the connectors of the apparatus (1) according to the invention described above.

Furthermore, in this embodiment, the housing (12) is designed such that the plurality of connectors it comprises provides at least one connector for connecting a charging cable for charging an electric vehicle (4), as well as a connector for connecting a further housing, which is designed identically to the first housing (12). It is thus possible for the user to set up a charging device for several electric vehicles (4, 41) by simply connecting several of the housings (12) comprised by the smart charging cable (1) according to the invention. Due to the easy-to-implement plug connections, once a charging station such as a wallbox has been set up by a specialist, there is no need to call in such a specialist to set up further charging connections.

Thereby, each of the plurality of housings (12) is designed in such a way that it has all the essential protective functions to protect the user, the electric vehicle (4) and its battery during the charging process. In particular, the housing (12) ensures protective earthing during the entire charging process. The housing (12) also comprises electronics for controlling and/or terminating the charging process of the electric vehicle (1) coupled to the housing via a charging cable. Furthermore, the electronics of each housing (12) comprises a communication interface which is set up to enable data communication between the housing and a computing unit (2), preferably a spatially remote, external computing unit. Thus, the charging processes of several electric vehicles can be controlled and/or terminated by the user, in particular remotely, by the housings (12) comprised by the charging cable (1) according to the invention.

In a preferred embodiment, the electronics integrated in the charging cable (1) according to the invention comprise an electricity meter. The electricity meter is preferably set up to monitor the electrical power delivered to the electric vehicle (4) by the charging station (3). In this way, the electrical power delivered to the electric vehicle (4) by the charging station (3) can be advantageously monitored without having to rely on data from the BMS. An additional on-board diagnostic system and/or connector, as well as a computing unit for evaluating the data from the BMS, are advantageously not necessary in order to access the charging data.

Furthermore, in one embodiment, the electronics of the smart charging cable (1) according to the invention comprise at least one optical readout means (13) (referred to herein as a display), which is set up in such a way that it can serve as a user interface. The user is thus advantageously able to easily read, for example, the status of the charging process, the power transmitted and/or to be transmitted and the charging capacities of the charging cable used. Preferably, the display is set up in such a way that a control command entered by the user via the display (13) can be executed. This has the advantage that the charging process can be controlled directly when coupling the electric vehicle (4) and the charging station (3) without the use of a computing unit.

According to one embodiment, the charging cable comprises a control/data line (101), the electronics being set up in such a way that it provides an interface to the control/data line.

As described at the beginning, the charging cable (1) according to the invention comprises at least one control/data line (101), which is used to transmit control signals between the charging station (3) and the BMS permanently installed in the electric vehicle (4). In a preferred embodiment, an interface to the control/data line (101) is provided by the electronics comprised by the charging cable (1) according to the invention. This has the advantage that control signals can be read out between the BMS, the charging station (3) and the smart charging cable (1). By means of the communication interface integrated in the electronics comprised in the charging cable (1) according to the invention, these control signals can be transmitted in the form of data to a computing unit (2), preferably a spatially remote, external computing unit. This makes it possible for the user to read the status of the charging process even from a distance.

Furthermore, the provided interface described for the control/data line (101) of the charging cable serves to transmit control commands to the charging station (3) and/or the electric vehicle (4). By means of the communication interface integrated in the electronics comprised by the charging cable (1) according to the invention, control signals can be transmitted from at least one computing unit (2), preferably a spatially remote computing unit, by the charging cable to the interface to the control/data line (101) of the charging cable (1) according to the invention. Thus, control and/or termination of the charging process by the user is advantageously ensured even from a distance.

In a further embodiment, the smart charging cable (1) according to the invention comprises a charging cable detection contact (102) which is designed in such a way that it can preferably be interrupted by the electronics. If the electronics send a signal to interrupt the charging cable detection contact (102), the charging process can be interrupted as a result, since the charging station (3) does not provide any power if it does not detect a coupled electric vehicle (4) via this connector. In a particularly preferred embodiment, the signal for interrupting the charging cable detection contact (102) can be transmitted by the user from a distance, i.e. a spatial distance, via the communication interface comprised by the electronics of the charging cable (1) according to the invention, so that the charging process can also be interrupted from a distance, as the flow of current is interrupted by the charging station (3) if an interrupted connection of the charging cable detection contact (102) is detected.

In a particularly preferred embodiment, the charging cable (1) according to the invention comprises a mechanism for ejecting the grid-side and/or vehicle-side connector (10), which is designed in such a way that it can be controlled remotely by means of the communication interface via a computing unit (2), preferably a spatially remote, external computing unit. Preferably, the mechanism comprises a mechanical ejection component, for example a spring or a switch. Thus, the smart charging cable (1) according to the invention can be ejected on the side of the charging station (3) and/or the electric vehicle (4), while it remains locked on the vehicle side and/or the side of the charging station. Thus, the charging station (1) can advantageously be released remotely for another electric vehicle (4) as soon as the charging process is complete. The term “from a distance” or a spatial distance refers to any position that is not in the immediate vicinity of the smart charging cable. For example, a remote position can be a position that is at least 5 meters, preferably at least 20 meters, particularly preferably at least 50 meters, particularly preferably at least 100 meters and particularly preferably at least 200 meters away from the charging cable in use. Preferably, the computing unit is located at this position.

Preferably, a charging station is unlocked and a charging cable is released when a predetermined charge level, i.e. a state of charge, has been reached. An app can also be used for this, via which a user can initiate the release. This has the advantage that the charging station infrastructure can be better utilized, as a subsequent user (second user) can unlock the charging cable of a previous user (first user) in order to plug in their charging cable instead. This process can also be referred to as “external unlocking”. Preferably, third-party unlocking is only possible once a predefined charge level has been reached. The first user can use an app to set the charge level at which they accept remote unlocking. The app can transmit this information to the app of a second user so that the second user is informed about the charging station at which it can eject the charging cable of a first user. It goes without saying that in the event of a third-party unlocking, the charging cable must be locked on the vehicle side after being ejected from the charging station in order to prevent theft of the charging cable.

In a particularly preferred embodiment, the communication interface comprised by the electronics of the charging cable (1) according to the invention is designed in such a way that it enables data transmission to a mobile device and/or a stationary computing unit and/or to a cloud-based computing system.

In a further preferred embodiment, the communication interface is set up in such a way that it enables data transmission to a mobile device and/or a stationary computing unit and/or a cloud-based storage medium. In this way, it is advantageously possible to achieve that, for example, collected data does not have to be stored on a storage device included in the smart charging cable, but can instead be transferred to an external storage and/or computing unit.

For the purposes of the invention, a cloud refers to a remote, distributed computing environment and/or at least one remote computing unit comprising at least one storage medium containing a computer program product which contains instructions for storing and/or evaluating received data.

For the purposes of the invention, a mobile device means a user-portable, operable computing unit comprising a storage medium containing a computer program product, also known as a software product, which contains instructions for storing and/or evaluating received data.

For the purposes of the invention, a stationary computing unit means a stationary computing system, in particular a PC, comprising a storage medium which contains a computer program product, also a software product, which contains instructions for storing and/or evaluating received data.

A communication interface set up in this way advantageously enables data transmission and evaluation of charging processes, including those of several electric vehicles (4) (41), to be carried out by a mobile device and/or a stationary computing unit and/or a cloud-based computing system.

Particularly preferably, data communication is carried out via the communication interface comprised by the electronics of the smart charging cable (1) according to the invention by means of at least one form of wireless data transmission. The wireless data transmission is carried out, for example, via a transmission format known from the prior art or a data transmission standard such as Bluetooth and/or WLAN and/or mobile communications (e.g. LTE or 5G) and/or LoRaWAN. By providing different transmission formats, compatibility with different computing systems and data formats can be enabled. The wireless data transmission, or the wireless connection of a computing unit (2), preferably a spatially remote, external computing unit, by means of the listed transmission formats enables the user to control and/or terminate the charging process remotely, as already described, and also establishes a secure, non-readable coupling between the charging cable (1) according to the invention and the computing unit (2).

Preferably, the data communication interface of the smart charging cable (1) according to the invention is set up in such a way that it can be operated by a user and/or an algorithm and/or an artificial intelligence, in particular a self-learning algorithm, by means of a computer program product, in particular an application (also: app). This allows the charging process to be controlled. In the context of the invention, an algorithm refers to an instruction or a sequence of instructions that are included in a computer program product. In the context of the invention, an app is a computer program product that is used for the purpose of implementing a function by a computing unit, in particular a mobile computing unit (e.g. a smartphone or a tablet).

Such a function includes, for example, sending a command to regulate the flowing charging current to the electronics included in the charging cable (1) according to the invention. Such a command can implement both the activation of a shunt comprised by the electronics and the interruption of the charging cable control contact (102).

In a further embodiment, a function realized by a computer program product comprises informing the user about electricity tariffs depending on the time of day. In this embodiment, the computing unit (2) containing and implementing the computer program product is configured to receive information regarding the current electricity tariffs via a communication interface. The computer program product is designed in such a way that it forwards this information to the user so that the user can use the available tariffs to make the charging process of an electric vehicle (4) cost-effective by suspending the charging process or continuing it with a higher or lower charging power. The computer program product is particularly preferably designed in such a way that it enables a user to enter a maximum electricity price and automatically pauses or resumes the charging process by sending control signals to the electronics comprised by the charging cable if the set price is exceeded or falls below. Thus, automated and/or manual, cost-optimized charging of an electric vehicle (4) can be realized by a smart charging cable (1) according to the invention.

Furthermore, automated and/or manual control of the charging process by means of the smart charging cable (1) according to the invention is thus advantageously realizable.

According to one embodiment, the charging process can be timed and/or interrupted via the computer program product, by a user and/or the algorithm and/or an artificial intelligence. Advantageously, this means that the user does not need to be actively involved in monitoring the charging process.

Advantageously, the communication interface integrated in the charging cable (1) according to the invention and set up as described above can also ensure that the charging process is controlled in terms of time by the user and/or an algorithm and/or artificial intelligence. For example, by entering a time window on the part of the user, the charging process can be designed in such a way that the charging process is completed at a selected time while optimally utilizing the charging capacities of the charging station (3) (e.g. depending on the number of electric vehicles (4) (41) charging at it) and/or taking into account the grid load. In another embodiment, a deployment plan of a company's service vehicle is stored on the storage medium of a computing unit (2), preferably a spatially remote, external computing unit, wherein the service vehicle is an electric vehicle (4). By means of a computer program product, which is also stored on the storage medium of the computing unit (2), preferably spatially remote, external computing unit, the deployment plan of the electric vehicle (4) can be retrieved, and the charging process of the electric vehicle can be controlled and/or interrupted via the smart charging cable (1) adapted to the times. In particular, an algorithm communicating via the communication interface and/or an artificial intelligence can enable time-based control of the charging process.

In a further embodiment, the charging cable (1) according to the invention can be coupled with a device that monitors the grid load, e.g. a smart meter. A smart meter is known to the skilled person as an instrument for reading and classifying the capacities of an electrical supply grid. It has a data communication unit for forwarding current consumption data of a load to a user and/or a computing unit. The coupling of the smart charging cable (1) according to the invention and the smart meter is preferably carried out via a data exchange between the data communication interface of the smart charging cable and a computing unit (2), preferably spatially remote, external computing unit, which is set up to receive data from the smart meter. This means that the charging process of the electric vehicle (4) coupled to a charging station (3) via the smart charging cable (1) can be controlled and/or interrupted depending on the grid load of the supply grid.

In a particularly preferred embodiment, the device according to the invention comprises an intelligent charging system, comprising a smart charging cable (1) according to one of the embodiments mentioned above, a charging station (3), a device to be charged (4), preferably an electric vehicle, and at least one computing unit (2) coupled to the smart charging cable in a wireless manner, preferably spatially remote, external computing unit, for controlling and/or terminating the charging process.

Preferably, the charging station comprises a mechanism that is set up to eject the grid-side connector, whereby the ejection can be controlled from a computing unit that is spatially remote from the charging cable. The charging cable is also set up so that the ejection can be realized. Preferably, this is a mechanical lock in the charging station. The signal for releasing the mechanical lock is preferably transmittable and controllable via the smart charging cable.

The present invention also comprises a method for controlling the charging power between a device to be charged (4), preferably an electric vehicle, and a charging station (3). The method according to the invention initially comprises providing an electric vehicle (4). Furthermore, the method comprises providing a charging station (3). The charging station (3) and the device to be charged (4) are designed in such a way that they are compatible for charging the device. A further step comprises coupling the device to be charged (4), in particular the electric vehicle, to the charging station (3) by a smart charging cable (1) as described above.

According to one embodiment, the method for controlling the charging power between a device to be charged and a charging station comprises
as a first step, providing a device to be charged,
as a second step, providing a charging station,
as a third step, coupling the charging station and the device to be charged with a charging cable as defined in one of the preceding claims,
as a fourth step, coupling the charging cable to at least one computing unit, and
as a fifth step, monitoring and/or controlling the charging power by means of an algorithm and/or an artificial intelligence and/or a computer program product and/or by means of electronics,
   wherein the electronics is arranged such that it monitors and/or adjusts the charging power at the charging station and the device to be charged by monitoring and/or adjusting the charging current at at least one phase.

In one embodiment, the coupled charging cable (1) according to the invention enables the charging process of the device to be charged (4), preferably the electric vehicle, to be monitored and/or controlled and/or terminated by the user via a display (13) comprising the smart charging cable (1), which serves as an operating console.

According to one embodiment, the smart charging cable (also: charging cable) comprises at least one sensor that is set up to detect a mechanical severing of the charging cable (e.g. in the event of vandalism). The sensor can, for example, comprise at least one metal thread, the severing of which triggers a message, in particular a message to the communication interface, a computing unit or a user, in order to inform them of a severing of the current line element. Preferably, at least one metal thread, preferably at least two metal threads, are arranged along the charging cable and are preferably covered by the material of the outer sheath of the charging cable. Cutting at least one of the metal threads preferably ensures that the power supply to the charging station is switched off immediately. This advantageously increases the safety of the persons (including the persons responsible for the severing) who are in the vicinity of the charging station, as the power supply is already interrupted even if none of the current-carrying wires inside the charging cable have been severed. It is clear to the person skilled in the art that the metal thread itself must carry a current, the interruption of which, caused by a charging cable cut, leads to sensor activity. In addition or as a supplement to the metal thread, a wire or phase can also be included in the sensor.

In a further embodiment, a handle by which a user grips the smart charging cable comprises a disinfectant. This is designed to reduce the number of germs on the handle, which has the advantage of preventing germs, in particular pathogens, from being transmitted to subsequent users.

A disinfectant can, for example, be designed in such a way that at least one blue light-generating means (e.g. blue light LED) is arranged in the handle in such a way that the handle surface is illuminated by the blue light. Alternatively or in addition to blue light, other parts of the electromagnetic spectrum can also be considered. The skilled person is aware of areas of the electromagnetic spectrum that have a damaging effect on microorganisms and/or proteins. Blue light, for example, is known to be effective in killing microorganisms in the wavelength range from 400 to 450 nanometers (nm). This works via the absorption of blue light by biomolecules (so-called porphyrins), which are omnipresent in living cells. In the presence of oxygen, these biomolecules, which are energetically stimulated by the blue light, form oxygen radicals in a chemical reaction which, due to their high reactivity, lead to cell damage, the prevention of reproduction or the killing of microorganisms.

According to an advantageous design, the smart charging cable is set up to map or emulate the requirements of the ISO 15118 standard, preferably ISO 15118 GEN 1 and/or ISO 15118 GEN 2. For charging devices, in particular electric vehicles, which do not support the ISO 15118 standard, the smart charging cable can advantageously take over the function of communication via this standard and convert the communication signals accordingly. As a result, a protocol handshake can preferably be realized, whereby an identification of the device to be charged, in particular the electric vehicle, is possible.

This allows a user-friendly and secure interface to be generated, which enables a plug-and-charge function. Activation is carried out simply by coupling the smart charging cable to the charging station. Advantageously, this eliminates the need for separate authentication through the use of a separate charging card for identification, whose identification is based on an RFID standard, for example, or through an app on a mobile device, such as a cell phone, or through an authorization program on a website, or an API. The smart charging cable can also be used to implement charging control via the ISO 15118 standard. In one embodiment, the charging cable is setup in such a way that the housing it comprises comprises at least three ports (also: charging cable connectors), whereby a first port can be electrically connected to the charging station or can be connected directly to the power grid or can be coupled to a socket (e.g. a conventional earthed socket). A second port can be electrically coupled to the device to be charged (e.g. an electric vehicle). A third and/or a fourth port can be electrically coupled to the housing of another charging cable of identical construction. This allows several smart charging cables to be electrically coupled together in a modular fashion. The in-cable control box of at least one of the interconnected smart charging cables, preferably the smart charging cable that is connected to the charging station, is set up to control the other smart charging cables and distribute the load to them. Thus, the charging processes of several electric vehicles coupled to the charging cables can be controlled via the device according to the invention. The housings can, for example, be arranged at a parking space for an electric vehicle. Preferably, the housings are designed to be installed in a fixed location.

An advantageous embodiment comprises a smart charging system consisting of a power grid connection and/or a wallbox coupled to a smart charging cable. The smart charging cable comprises at least one, preferably at least two or at least three modular or modular-like housings. The housing or housings are stationary, i.e. mounted or installed at a fixed distance from each other and from the wallbox or power grid connection. The housings thus function as an additional charging option, which fulfills high safety requirements analogous to an installed wallbox. According to an advantageous embodiment, components of the power electronics, such as relays and/or power electronic switches, for example contactors (also electric contactors), and/or protective shutdowns, are intended in each housing for this purpose. This enables decentralized power electronics, which is advantageous for decentralized charging.

According to an advantageous embodiment, such a housing is designed as an in-cable control box. This enables safety and communication functions, in particular for controlling the charging process. The advantage of this is that decentralized charging, i.e. charging away from the wallbox, can be implemented without having to compromise on safety requirements. Each housing provided with a charging connection or a charging cable connector then functions advantageously as a separate wall charging station, i.e. it performs almost all the functions that a wall charging station also performs.

The fixed installation of the housings means that safety disadvantages due to loose cables can be avoided. Each housing is designed to be installed in a fixed position. Advantageously, the housing or housings can be modularly coupled with other smart charging cables comprising identical construction housings. Each of these housings comprises at least one charging connector or charging cable connector.

Due to its modular setup, such a system can advantageously be easily extended by another smart charging cable with a housing with a charging connector or charging cable connector, so that several stationary housings functioning as charging stations can be installed without having to install another wallbox.

According to another possible embodiment, the smart charging system comprises a wallbox and/or a power grid connection coupled with a smart charging cable. In this embodiment, the housing comprises at least two charging connectors or charging cable connectors. The smart charging cable acts as a distributor. Preferably, the housing is mobile or permanently installed.

According to a suitable embodiment, each of these housings comprises power electronics components, such as relays and/or power electronic switches, for example contactors (also electric contactors), and/or protective shutdowns. This enables decentralized power electronics, which is advantageous for decentralized charging.

The charging station or wallbox generally requires installation by a specialist. If a user who is not a specialist wishes to position charging options at other locations, the device according to the invention can be used to easily connect the smart charging cables to each other and/or to the charging station. The fact that the housings can be arranged anywhere in a room (e.g. a wall or on a ceiling), whereby only the corresponding ports need to be coupled together, means that there is no risk of cables lying around on the floor, which increases safety during charging. The smart charging cables coupled together can also be referred to as a modular charging cable system for the spatial arrangement of charging cables in a room.

The integrated electronics allow each port to automatically determine whether it is coupled to the charging station, to a first, second, third, fourth or another port of another charging cable. Accordingly, the distribution of the current flow through the ports is also controlled in such a way that the respective charging cable can effectively charge the device (e.g. electric vehicle) connected to this charging cable.

Preferably, the smart charging system is designed in such a way that at least two, preferably at least three housings are coupled together and installed in a fixed position, with only one of the housings being coupled to the charging station via a smart charging cable according to the invention. Preferably, each housing comprises power electronics components. According to an advantageous embodiment, the connection between the housing coupled to the charging station, preferably to the wallbox, and the other housings is also realized by a charging cable according to the invention. In this way, the overall length of the smart charging cable can be advantageously shortened.

According to an alternative embodiment of the smart charging system, several housings are coupled directly to the charging station, preferably to the wallbox, via a smart charging cable. In this way, the allocation of the inflow can be regulated directly in the charging station. It may be intended that the housings are installed in switch cabinets. This means that only the charging cable is visible.

In a further embodiment, the electronics arranged in the smart charging cable, in particular the electronics arranged in the housing of the smart charging cable, comprise a communication interface. The communication interface is designed in such a way that it enables connection to a computing unit, in particular a remote, distributed computing environment, also known as a cloud, via mobile communications (e.g. LTE) and/or radio networks, for example also wireless LAN connections or a radio technology such as Bluetooth. Thus, the charging process can be controlled and/or terminated via the cloud using a computer program product. According to an advantageous embodiment, communication between the charging cables is carried out via a LIN BUS. This is particularly suitable for permanently installed, especially stationary, intelligent charging cables.

Preferably, detection of a location and/or detection of occupancy of a charging station, such as a parking space or a charging space at a charging station, is carried out using external sensors. The external sensors are preferably arranged in the ground in such a way that a vehicle located there, in particular an electric vehicle, can be detected by driving over it. Communication between the sensors and the smart charging cable can be realized by means of a radio standard, such as Bluetooth.

According to an advantageous embodiment, the charging station and/or the smart charging cable comprises sensors for detecting a vehicle. For example, an assignment is possible by means of license plate recognition or recognition based on RFID, so that location recognition is possible.

In a further step, the method according to the invention for controlling the charging power comprises coupling the smart charging cable (3) with at least one computing unit (2), preferably a spatially remote, external computing unit. The coupling is preferably carried out via wireless data transmission by means of a communication interface included in the smart charging cable (1). The computing unit (2) is preferably a spatially remote computing unit, in particular a distributed computing environment or a mobile device.

In a further step, the method according to the invention for controlling the charging power comprises monitoring and/or controlling the charging power by means of a computer program product, also software product, which can be controlled by a user and/or an algorithm, and/or by electronics which is set up in such a way that it monitors and/or adjusts the charging power at the charging station (3) and the device to be charged (4) by monitoring and/or adjusting the charging current at at least one phase.

Such a method offers the advantage that the user can set and/or interrupt the charging process of a device to be charged (4) from a distance and/or adapted to current consumption data and time sequences.

The invention also relates to the use of the smart charging cable defined herein for coupling and charging a device to be charged (4), in particular an electric vehicle, at charging stations with or without charging power control. Since the smart charging cable (1) has the necessary electronics for monitoring the charging power as well as all essential protective functions to protect the user, the device to be charged (4) and the battery of the device to be charged during the charging process, the smart charging cable can also be used in conjunction with charging stations of an older generation that are not designed to monitor the current grid power. Furthermore, the charging cable (1) according to the invention can be used, for example, to charge electric vehicles (4) (41) from a company's vehicle fleet in order to synchronize the charging process of several electric vehicles.

### EXAMPLES OF IMPLEMENTATION

The present invention is explained in more detail with reference to the following figures and embodiments, without limiting the invention to these.

It shows

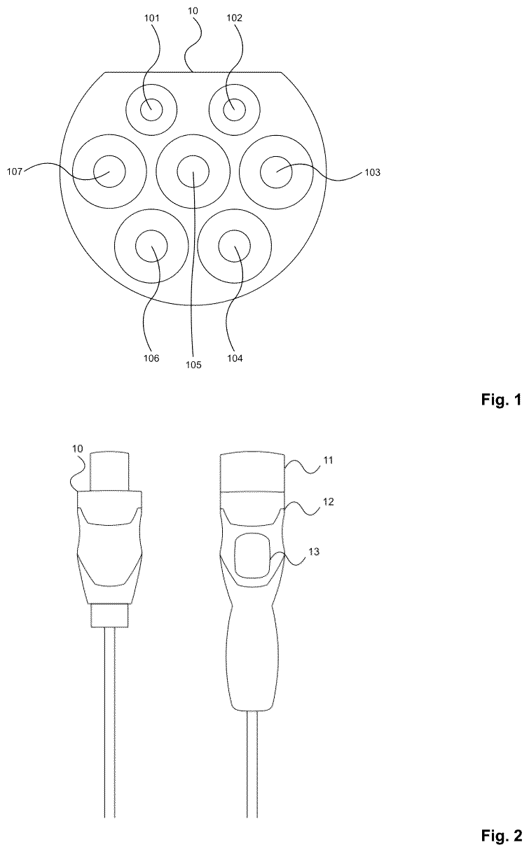

FIG. 1 a schematic view of a grid-side charging cable connector (10) of the device according to the invention, wherein existing charging cable connector contacts (101-107) are shown

FIG. 2 a schematic view of the device according to the invention, showing the charging cable connectors (10) (11) in their entirety

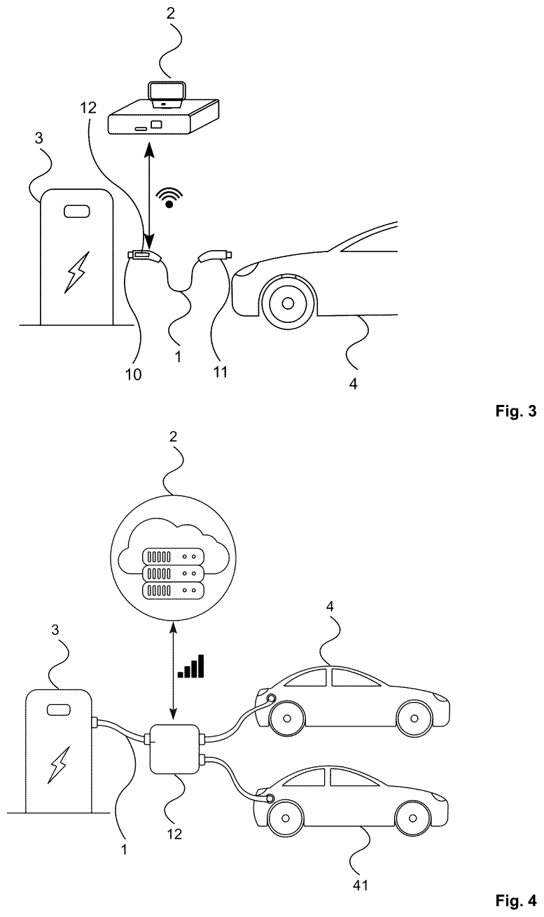

FIG. 3 a schematic view of the use of the device according to the invention for coupling an electric vehicle (4) to a charging station (3), wherein the charging process of the electric vehicle can be monitored by coupling the charging cable (1) according to the invention to a remote computing unit (2), designed in such a way that the coupling of the charging cable to the computing unit is carried out via a communication interface integrated in the grid-side plug head of the charging cable and enclosed by a housing (13) via WLAN

FIG. 4 a schematic view of the use of the device according to the invention for coupling a plurality of electric vehicles (4), (41) wherein the charging process of the electric vehicles can be monitored by coupling the charging cable (1) according to the invention with a computing unit (2), in particular a cloud, designed in such a way that the coupling of the charging cable with the computing unit is carried out via a communication interface via LTE, which is comprised by a housing (12).

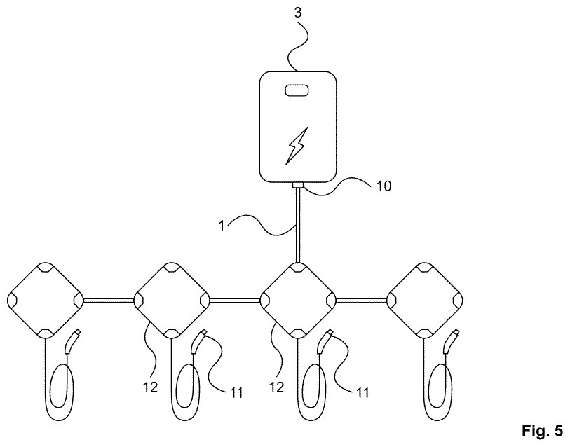

FIG. 5 A schematic view of a smart charging cable with a housing designed as an in-cable control box, which is coupled with two other charging cables.

In a first embodiment example, FIG. 1 discloses a charging cable connector (10) (11) of a charging cable (1) according to the invention for coupling a device to be charged (4), in particular an electric vehicle with a charging station (3). The illustrated grid-side charging cable connector (10) of the charging cable according to the invention is a three-phase charging cable connector with a plug conforming to the EN 62196 type 2 standard, comprising two signal contacts, the signal contacts being designed in such a way that they are a charging cable detection contact (102) and a control/data line (101). Further, the charging cable connector comprises five contacts for power transmission, the contacts being arranged such that they comprise a neutral line (107), a protective earth (105) and three outer phases (103) (104) (106), herein referred to as phases. The phases (103) (104) (106) are designed in such a way that they enable a current flow from the charging station (3) to the device to be charged (4). The protective earth (105) is designed to ensure earthing and personal protection during charging. The neutral line (107) is designed in such a way that it ensures the equalization of phase shifts of the currents in the phases. Preferably, the charging cable connector (11) on the device side is designed in such a way that it is of identical construction to the grid-side charging cable connector (10).

Alternatively, the charging cable (1) according to the invention can be a single-phase charging cable. The device-side charging cable connector (11) of the smart charging cable (1) is designed in such a way that it comprises two signal contacts, analogous to the first embodiment example described above, and three contacts for energy transmission, whereby the contacts are designed in such a way that they comprise a neutral line (107), a protective earth (105) and a phase (103). The functions realized by the contacts for energy transmission correspond to those of the first embodiment example. Preferably, the charging cable connector (11) of the charging cable (1) on the device side is designed such that it comprises two dummy contacts in order to ensure compatibility with other connection systems.

In FIG. 2, the grid-side (10) and device-side (11) charging cable connector are disclosed. The grid-side charging cable connector (10) is designed such that it comprises a housing (12), the housing comprising electronics designed to control and/or terminate the charging process of a device to be charged (4) coupled to a charging station (3) by a charging cable (1) according to the invention. In this embodiment example, the housing (12) comprises an optical readout means, also display (13), which is designed in such a way that inputs by the user via the display can be processed by the electronics and the charging process can thereby be controlled and/or terminated. Furthermore, information about the charging process can be read on the display (13).

FIG. 3 discloses in one embodiment the use of the smart charging cable (1) according to the invention for controlling and/or terminating the charging process of a device to be charged, in this case an electric vehicle (4) at a charging station (3). The charging station (3) to which the charging cable (1) according to the invention is connected is a charging station which does not include a charging power control. The charging power cannot be regulated via the charging station (3) and cannot be adapted to the grid load.

In this embodiment, the smart charging cable (1) according to the invention in this example is a three-phase charging cable. The charging cable has a charging cable connector on the vehicle side (11) and on the grid-side (10) with a plug that conforms to the EN 62196 type 2 standard, as disclosed in FIG. 1.

Furthermore, the smart charging cable (1) according to the invention has a housing (12) which is directly downstream of the grid-side charging cable connector (10). In particular, in this embodiment, the housing (12) is integrated into the plug head of the grid-side charging cable connector (10).

In this embodiment, the device according to the invention comprises an electronic unit enclosed by the housing (12). The electronics are designed in such a way that they enable a communication interface for coupling the smart charging cable (1) according to the invention with a computing unit (2) via a wireless data transmission format. In this embodiment example, the communication interface is designed in such a way that it enables data transmission via WLAN.

Furthermore, the electronics comprise a module for controlling the three phases (103) (104) (106) of the smart charging cable (1) according to the invention, which is designed in such a way that each phase can be controlled individually and the current flow along each phase can be interrupted individually. The module is characterized in that it can be controlled by a signal received from the communication interface.

In this embodiment, the module comprises controllable resistors, in particular shunts, which are connected in parallel with the three phases (103) (104) (106). By connecting the shunts in parallel, the current flow is prevented via at least one phase. The charging power can therefore be controlled via the module.

FIG. 3 also shows the coupling of the device according to the invention with a computing unit (2), in particular a remote computing unit. The coupling is carried out here via the communication interface comprised by the electronics of the smart charging cable (1) according to the invention and a communication interface integrated in the computing unit (2). Thus, data can be exchanged between the smart charging cable (1) according to the invention and the computing unit (2). The charging process can thus be controlled and/or terminated by a user and/or by a computer program product stored on a storage medium comprised by the computing unit (2).

In addition, it may be intended that the electronics comprised by the smart charging cable (1) according to the invention are designed such that they comprise a module which increases and/or decreases the resistance of the individual phases by means of resistance elements connected in series. This means that the charging power can be regulated individually on each individual phase. In this embodiment, the electronics comprise an electronic potentiometer.

It is also conceivable that the computing unit (2) is designed to receive information from a device that monitors the grid load. In this embodiment example, the device monitoring the grid load is a smart meter. The smart charging cable (1) according to the invention is designed in such a way that it controls and/or terminates the charging process of the coupled electric vehicle (4) via the communication interface it comprises through the coupled computing unit (2) on the basis of the information provided by the smart meter.

FIG. 4 shows a further embodiment of a smart charging cable (1) according to the invention, which comprises a housing (12) downstream of the grid-side charging cable connector (10). Herein, the housing and the electronics it comprises are housed separately from the plug heads of the vehicle-side (11) and grid-side (10) charging cable connectors in an in-cable control box.

The in-cable control box is designed in such a way that it provides several charging cable connectors.

Furthermore, the in-cable control box includes electronics that enable the connected charging cables to be controlled separately. Thus, the charging processes of several electric vehicles (4) (41) coupled to the charging cables can be controlled via the apparatus (1) according to the invention.

In this embodiment example, the electronics further comprise a communication interface. The communication interface is designed in such a way that it enables connection to a computing unit (2), in particular a remote, distributed computing environment, also known as a cloud, via mobile communications (e.g. LTE). This means that the charging process can be controlled and/or terminated via the cloud using a computer program product.

Furthermore, an embodiment is conceivable in which the smart charging cable (1) according to the invention comprises a mechanism on the grid-side charging cable connector (10) which is designed in such a way that the grid-side charging cable connector (10) of the charging cable (1) according to the invention can be ejected after the charging process has ended. After the charging process has ended, the charging station (3) is thus advantageously recognizable as released for other users and can continue to be used immediately.

FIG. 5 shows further embodiment example of the charging cable (1) according to the invention comprising a housing (12), wherein the housing (12) is designed in such a way that it is realized as an in-cable control box. In this embodiment example, the grid-side charging cable connector (10) is permanently coupled to a charging station (3). In this embodiment example, the charging station (3) is a wallbox. The housing (12) comprising the charging cable according to the invention is designed in such a way that it provides at least one connector for a further charging cable comprising a housing (12). In this embodiment example, two further charging cables, each comprising a housing (12), are connected to the first housing (12). A further charging cable comprising a housing (12) is also connected to one of the housings (12). Each housing (12) is arranged such that it comprises a cable with a charging cable connector (11) on the vehicle side. Thus, the setup realized in this embodiment example provides four connectors for charging an electric vehicle (4).

In addition, it should be noted that the skilled person will undoubtedly recognize that the individual features described in the above specific embodiments can be combined with each other in an appropriate manner, provided there is no contradiction, whereby a separate description of various possible combinations is dispensed with in order to avoid unnecessary repetition.

### LIST OF REFERENCE SIGNS

1 Smart charging cable
2 Computing unit
3 Charging station
4 Device to be charged
10 Grid-side charging cable connector
11 Charging cable connector on the device side
12 Housing
13 Display
41 Additional electric vehicle
101 Control/data line
102 Charging cable detection contact
103 First phase
104 Second phase
105 Protective earth
106 Third phase
107 Neutral line

1-17. (canceled)

18. A smart charging cable (1) for regulating the charging power of accumulators of devices to be charged, in particular electric vehicles, the smart charging cable having
an at least single-phase, grid-side charging cable connector (10), wherein this is set up as a coupling element of the charging cable (1) and a charging station (3),
an at least single-phase charging cable connector (11) on the vehicle side, this being set up as a coupling element of the charging cable (1) and a device (4) to be charged, and
a housing (12), comprising electronics, wherein this is set up for setting a charging power,
a mechanism which is set up to eject the grid-side and/or vehicle-side connector (10, 11)
characterized in that
the electronics are set up for monitoring and/or adjusting the charging current on at least one phase,
the electronics comprise a communication interface which is configured in such a way that it has at least one signal transmission means which is configured for transmitting a data signal or a data sequence to at least one computing unit (2),
wherein the communication interface is configured in such a way that it enables data communication with the computing unit (2), wherein the computing unit is configured to monitor and/or adjust the charging power,
wherein the ejection can be controlled by a computing unit (2) which is spatially remote from the charging cable (1)
wherein the computing unit (2) is an external, mobile computing unit or a stationary computing unit or a distributed computing unit or an internal computing unit.

19. The smart charging cable according to claim 18, wherein an algorithm communicating via the communication interface and/or by means of an artificial intelligence enables a time-based control of the charging process.

20. The smart charging cable according to claim 18, wherein the electronics comprise an electricity meter arranged to monitor the power delivered by the charging station (3) to the device to be charged (4).

21. The smart charging cable according to claim 18, wherein the communication interface of the charging cable (1) is set up to communicate with a device monitoring the network load, in particular a smart meter.

22. The smart charging cable according to claim 18, wherein the communication interface is set up in such a way that it enables data transmission to a mobile device and/or a stationary computing unit and/or a cloud-based storage medium.

23. The smart charging cable according to claim 22, wherein the communication interface enables wireless transmission of data communication signals.

24. The smart charging cable according to claim 18, wherein the charging cable (1) is set up to be operable by a user and/or an algorithm and/or an artificial intelligence via the communication interface by means of a computer program product, in particular an app installed on a mobile device.

25. The smart charging cable according to claim 18, wherein the housing (12) comprised by the charging cable (1) provides a charging cable connector for at least one further charging cable.

26. The smart charging cable according to claim 18, wherein the housing (12) comprised by the charging cable (1) is arranged such that it can be coupled by a user to a charging unit and at least one further housing, so that at least one charging option for a device (4) to be charged is provided on each coupled housing.

27. The smart charging cable according to claim 18, wherein the electronics comprised by the smart charging cable (1) is designed in such a way that it has a module which increases and/or decreases the resistance of the individual phases by means of series-connected resistance elements.

28. The smart charging cable according to claim 18, which is set up to map the requirements of the ISO 15118 standard, whereby a plug-and-charge function is realized.

29. A smart charging system comprising a smart charging cable (1) according to claim 18, comprising a housing (12) comprising electronics, and a charging station (3) and/or an electric vehicle (4)
characterized in that
the electronics comprise a communication interface which is set up in such a way that it comprises at least one signal transmission means which is set up for transmitting a data signal or a data sequence to at least one spatially remote, external computing unit (2),
wherein the communication interface is designed in such a way that it enables data communication with the spatially remote, external computing unit (2), wherein the computing unit is set up to monitor and/or adjust the charging power,
wherein the charging cable (1) comprises a mechanism which is set up to eject the grid-side and/or vehicle-side connector (10, 11), wherein the ejection can be controlled from a spatially remote, external computing unit (2) which is spatially remote from the charging cable (1).

30. The intelligent charging system according to claim 29, wherein the charging station (3) has a mechanism which is set up to eject the grid-side connector (10, 11), and wherein the smart charging cable (1) is set up to enable such ejection, wherein the ejection can be controlled by a spatially remote, external computing unit (2).

31. The smart charging system according to claim 29, comprising a charging station (3) preferably designed as a wallbox, which is coupled to a smart charging cable (1), wherein the housing (12) of the smart charging cable (1) is arranged to be installed in a stationary manner or is installed in a stationary manner,
wherein the housing (12) is modularly connectable to further housings (12) of identical construction,
wherein the housing (12) has at least one charging cable connector (11).

32. The smart charging system according to claim 31, wherein at least two, preferably at least three housings (12) are coupled to each other and installed in a stationary manner, wherein exclusively one of the housings (12) is coupled to the charging station (3) via the smart charging cable (1).

33. A method for controlling the charging power between a device (4) to be charged and a charging station (3), comprising the following steps:
a) providing (S01) a device (4) to be charged,
b) providing (S02) a charging station (3),
c) coupling (S03) the charging station (3) and the device (4) to be charged with a charging cable (1) as defined in claim 18,
d) coupling (S04) the charging cable (1) with at least one computing unit (2),
e) monitoring (S05) and/or controlling (S06) the charging power by means of a user and/or an algorithm and/or an artificial intelligence and/or a computer program product and/or by means of electronics according to one of the preceding claims, wherein the electronics is arranged such that it monitors and/or adjusts the charging power at the charging station (3) and the device to be charged (4) by monitoring and/or adjusting the charging current at at least one phase,
characterized in that
the electronics comprises a communication interface which is set up such that it comprises at least one signal transmission means which is set up for transmitting a data signal or a data sequence to at least one spatially remote, external computing unit (2)
wherein the communication interface is designed in such a way that it enables data communication with the spatially remote, external computing unit (2), wherein the computing unit is set up to monitor and/or adjust the charging power,
wherein the charging cable (1) comprises a mechanism which is set up to eject the grid-side and/or vehicle-side connector (10, 11), wherein the ejection can be controlled from a spatially remote, external computing unit (2) which is spatially remote from the charging cable (1).
